(19) United States
(12) Patent Application Publication
(10) Pub. No.: US 2024/0378316 A1
(43) Pub. Date: Nov. 14, 2024

(54) SYSTEMS AND METHODS FOR RESTRICTING ACCESS TO CAPTURED IMAGES

(71) Applicant: Oakley, Inc., Foothill Ranch, CA (US)

(72) Inventor: Ryan SAYLOR, Mission Viejo, CA (US)

(21) Appl. No.: 18/658,792

(22) Filed: May 8, 2024

Related U.S. Application Data
(60) Provisional application No. 63/502,025, filed on May 12, 2023.

(51) Int. Cl. G06F 21/62; H04N 23/60

(52) U.S. Cl. CPC G06F 21/6245; H04N 23/64; G06F 2221/2141

(57) ABSTRACT

Disclosed herein are system, method, and computer readable media embodiments for controlling the capture and sharing of an image and/or video of a subject by a third party device. In some embodiments, an electronically-enabled wearable device worn by a subject may detect an active, nearby camera-capable device. Identification information for a user associated with the camera-capable device may be requested and received from the camera-capable device. An authorization level may then be determined for the user based on the identification information. In some embodiments, a camera control signal and/or authorization metadata may be generated based on the authorization level of the user and sent to the camera-capable device, for transmission to the camera-capable device.

### CROSS-REFERENCE TO RELATED APPLICATIONS

This application claims the benefit of U.S. Provisional Application No. 63/502,025, filed May 12, 2023, which is incorporated herein by reference in its entirety.

### BACKGROUND

With the growing use of smart phones and other camera-capable devices to capture images and videos, a person may have their image captured and shared by others without their knowledge or consent. As the use of social media has become ubiquitous, consumers are becoming more aware of the importance of online privacy and the need to closely manage their online footprint. As such, the need for a mechanism to give consent to or deny the capture and/or sharing of one's own image has become more pronounced.

### BRIEF DESCRIPTION OF THE DRAWINGS

Aspects of this disclosure are best understood from the following detailed description when read with the accompanying figures. It is noted that, in accordance with the common practice in the industry, various features are not drawn to scale. In fact, the dimensions of the various features may be arbitrarily increased or reduced for clarity of discussion.

FIG. 1 illustrates a block diagram of a system for controlled sharing of media including a subject and captured by a camera-capable device associated with a user, in accordance with some embodiments.

FIG. 2 illustrates a visual representation of the social network of a subject, in accordance with some embodiments.

FIGS. 3A and 3B illustrate flowcharts of example methods for implementing controlled sharing of media including a subject and captured by a camera-capable device associated with a user, in accordance with some embodiments.

FIG. 4 illustrates a visual representation of the example methods of FIGS. 3A and 3B, in accordance with some embodiments.

FIG. 5 illustrates user interfaces for viewing and downloading media including a subject and captured by a camera-capable device associated with a user, in accordance with some embodiments.

FIG. 6 illustrates a visual representation of the social networks of multiple subjects in relation to a user of a camera-capable device, in accordance with some embodiments.

FIG. 7 illustrates an example computer system in accordance with some embodiments.

Illustrative embodiments will now be described with reference to the accompanying drawings. In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for controlling the capture and sharing of an image and/or video of a subject by a third party device. The authorization process may be initiated when a sensor located on an electronically-enabled wearable device, worn by the subject detects the activation of camera on a nearby camera-capable device. The identity of the person (also referred to as a user) associated with the camera-capable device may be retrieved and compared against the subject's social network to determine if the user is connected/known to the subject. The level of authorization to access and/or share the image/video captured granted to the camera-capable device and the associated identity may be based on whether the person associated with the camera-capable device is within the subject's social network. The access level granted may be enforced via metadata that is sent to the camera-capable device and embedded in the captured image/video. The metadata is configured to limit sharing of the captured media to sharing activities permitted for the granted access level. In some embodiments, a camera blocking signal may be sent to the camera-capable device to prevent the camera-capable device from capturing an image/video. This signal may work by, for example, sending a signal at a particular frequency that blocks the media capturing function of the camera of the camera-capable device, or sending instructions that otherwise confuse or block the media capturing function of the camera of the camera-capable device.

Embodiments herein shall be described with reference to images as the media being captured by the camera-capable device. However, a person of skill in the art will appreciate that a similar authorization process may be used to control access of a third party to capturing, viewing, sharing, and/or saving any form of media that can be captured by camera-capable device (e.g., image, audio, video, etc.).

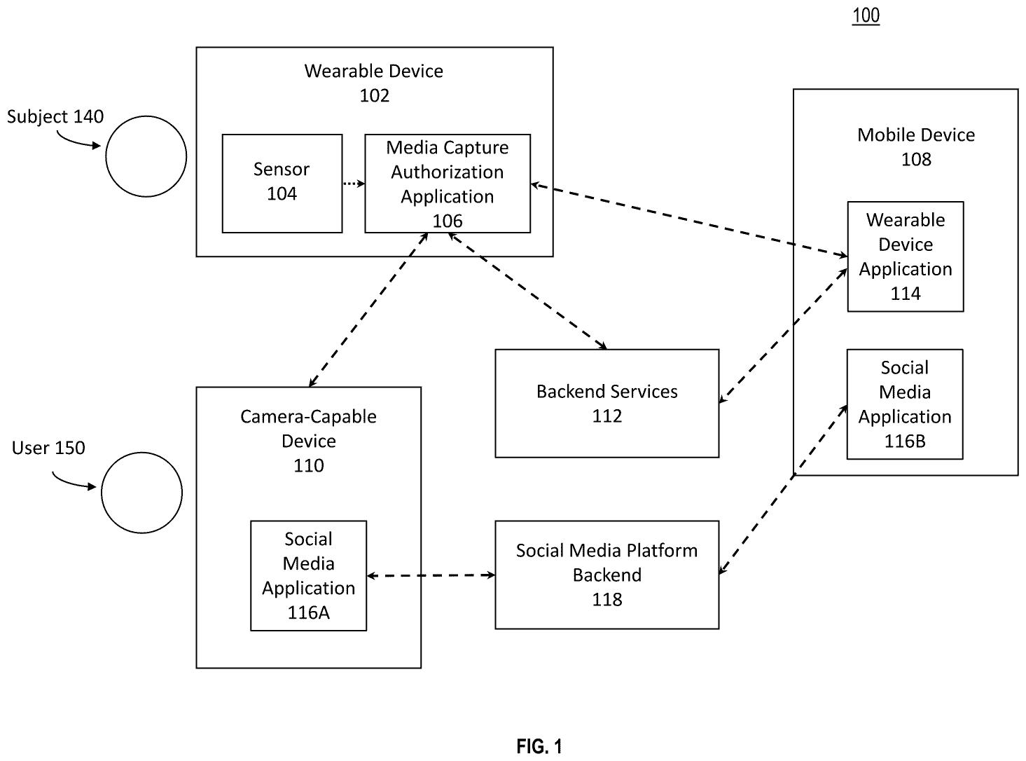

FIG. 1 illustrates a block diagram of a system for controlled sharing of media including a subject 140 and captured by a camera-capable device associated with a user 150, in accordance with some embodiments.

In some embodiments, system 100 may include electronically-enabled wearable device 102, mobile device 108, camera-capable device (CCD) 110, and backend services 112. These devices may be communicatively and/or operatively coupled together via one or more wired connections, wireless connections, or a combination of wired and wireless connections as part of one or more communications networks as illustrated in FIG. 1.

Wearable device 102 may be associated with and worn by subject 140. In some embodiments, wearable device 102 may be an electronically-enabled eyewear device (e.g., goggles, face shield, eyeglasses, sunglasses, etc.). Alternatively, wearable device 102 may be another wearable object, such as a helmet, shoulder pad, armband, jacket, etc., on which a sensor can be placed. Wearable device 102 may include sensor 104 and image authorization application 106.

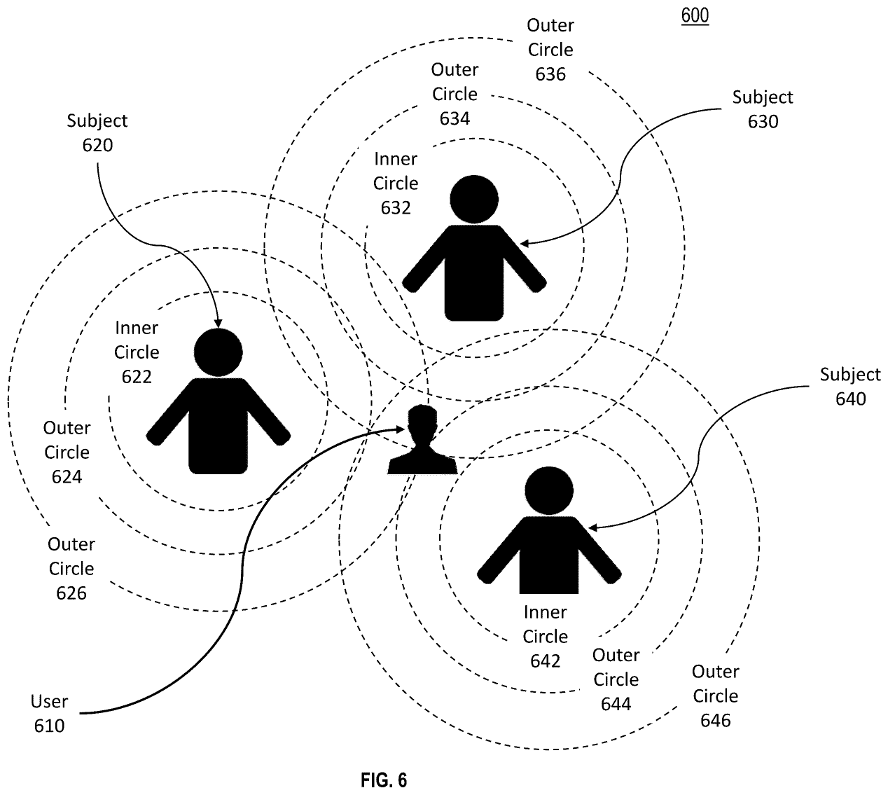

While FIG. 1 illustrates an embodiment comprising a single subject 140 wearing wearable device 102 and a single camera user 150, the system, methods, and/or processes described herein may be applied to embodiments including 2 or more subjects 140 and/or camera users 150. An example embodiment including multiple subjects 140 is depicted in and described below with reference to FIG. 6.

Sensor 104 may include one or more sensors configured to detect nearby camera-capable devices 110. For example, when wearable device 102 is eyewear, sensor 104 may include a first sensor on one outward-facing side of the eyewear, and a second sensor on an opposite outward-facing side of the eyewear. In another example, when wearable device 102 is a helmet, sensor 104 may include a 370° sensor located on a top surface of the helmet. Sensor 104 may be configured to detect when a camera of camera-capable device 110 is active. In some embodiments, sensor 104 may be configured to detect when subject 140 is within the field of view of the camera of camera-capable device 110 such that subject 140 will be in the image captured by the camera. Sensor 104 may achieve this using a number of methods.

Sensor 104 may include one or more types of sensors, including, but not limited to, electrical, optical, audio, etc. In some embodiments, sensor 104 may include a component configured to conduct polling at predetermined time intervals to detect whether a camera-capable device 110 is within range. This range may be a radius within a predetermined, fixed distance of wearable device 102 (and subject 140). Alternatively, the range distance may be configured by subject 140. For example, subject 140 may use wearable device application 114 on mobile device 108 to configure the range at which they would like to initiate controlled sharing of images of them taken by a third party. In some embodiments, sensor 104 may include one or more range finders for detecting a camera-capable device 110 that is within range. In some embodiments, sensors may be utilized to detect whether subject 140 is within the field of view of camera-capable device 110's camera. For example, sensor 104 may use glint detection to determine whether the camera in camera-capable device 110 is pointed at sensor 104 (and thus subject 140). In some embodiments, sensor 104 may detect when the camera is active/open and/or pointed at sensor 104 (and thus subject 140). For example, sensor 104 may detect a signal output by the camera or camera-capable device 110, such as the camera or device 110's own infrared light or LiDAR (Light Detection and Ranging) signal.

In some embodiments, wearable device 102 may execute software applications including, but not limited to, image authorization application 106. Image authorization application 106 may receive and process sensor data from sensor 104 to determine whether a camera-capable device 110 is within range and whether conditions for initiating an image sharing authorization process (“authorization initiation conditions”) with the camera-capable device 110 have been met. As used herein, and in some embodiments, “authorization initiation conditions” may refer to a set of conditions that must be met to initiate. These conditions may include one or more of the following:
a camera-capable device 110 is detected;
camera-capable device 110 is within a predetermined distance (range) of wearable device 102;
the camera of camera-capable device 110 is active (in image/video capturing mode); and/or
subject 140 is within the field of view of the camera of camera-capable device 110.

For example, image authorization application 106 may receive data indicating that a device has been detected. This data may include but is not limited to information about the device, the distance of the device from subject 140, whether a camera light is detected, etc. Image authorization application 106 may then use this information to determine whether the detected device is camera-capable and within the determined range. In some embodiments, image authorization application 106 may further determine if the camera of the detected device is active. The camera of camera-capable device 110 may be considered to be active when it is ready to capture an image/video. For example, if camera-capable device 110 is a smart phone, the camera is considered to be active when the camera application is open and in the foreground of the smart phone's user interface. As many mobile device cameras use a range-finding signal in order to properly focus an image, the detection of such a range-finding signal by sensor 104 may indicate that the camera on camera-capable device 110 is active and/or pointed at sensor 104 such that subject 140 is within a field of view of the camera.

In some embodiments, image authorization application 106 may be configured to communicate directly or indirectly with camera-capable device 110, mobile device 108, and/or backend services 112. Image authorization application 106 may, in conjunction with a communications interface on wearable device 102, communicate with camera-capable device 110 to request information for identification of user 150 and send authorization metadata to be embedded in images capturing subject 140. Image authorization application 106 may communicate with subject 140's mobile device 108 to receive configuration changes subject 140 may have made using wearable device application 114 and request information about whether user 150 is connected to user 140's social network. In some embodiments, image authorization application 106 may communicate with backend services 112 directly to determine whether user 150 is within the social network of user 140. In some embodiments, image authorization application 106 does not communicate directly with camera-capable device 110 or backend services 112, but rather only communicates with mobile device 108 to indicate that a detection has occurred. Mobile device 108 itself then communicates with camera-capable device 110 and/or backend services 112.

Backend services 112 may include one or more datastores as well as one or more backend applications executing on one or more computing devices (e.g., servers, mainframes, etc.). Additionally or alternatively, backend services 112 may include cloud-based storage and/or cloud computing services.

Mobile device 108 may be a smart phone, tablet computing device, portable media player, and/or the like. In some embodiments, mobile device 108 may be generally configured to execute one or more mobile applications, which may include, without limitation, wearable device application 114 and social media application 116B. Wearable device application 114 may be provide user interfaces for configuring user privacy preferences related to the access and sharing of images of user 140 taken by a third party camera-capable device. Wearable device application 114 may also allow subject 140 to configure other user preferences related to the use of wearable device 102. User preferences for wearable device 102 may be stored/backed up in the one or more datastores of backend devices 112. Accordingly, wearable device application 114 may communicate with backend services 112 to upload updated user preferences for subject 140 and configurations for wearable device 102. Communications between wearable device application 114 and backend services 112 may occur via one or more communication networks. The communication networks may include any combination of a private network, personal area network (PAN), Local-Area Network (LAN), Wide-Area Network (WAN), cellular network, etc. Further, the connection between wearable device application 114 and backend services 112 may be a wireless connection (e.g., Bluetooth or other short range wireless technology, cellular, Wi-Fi connection, etc.). In some embodiments, mobile device 108 is mounted on, embedded in, or otherwise a part of wearable device 102. In other embodiments, mobile device 108 is separate from wearable device 102. In some embodiments, authorization processes are executed and communicated directly to other users by wearable device 102. In some embodiments, authorization processes are executed by wearable device 102 using mobile device 108 as a communications pass-through. In some embodiments, wearable device 102 simply sends detection information to mobile device 108, where mobile device 108 is solely responsible for executing any authorization processes. For example, where application 106 on wearable device 102 sends detection information to mobile device 108, wearable device application 114 may receive such communication and itself conduct the media capture authorization process with camera-capable device 110 and/or backend services 112. In such embodiments, authorization functionality described above as part of media capture authorization application 106 is instead performed by wearable device application 114.

Camera-capable device 110 may be an internet enabled device comprising at least a camera and a memory (e.g., smart phone, digital camera, tablet, wearable device, etc.). Camera-capable device 110 may be associated with a user 150 and store identification and/or user profile information for user 150 in memory. Camera-capable device 110 may also be capable sending and receiving data via wireless communication. Camera-capable device 110 may configured to execute one or more applications, which may include, without limitation, social media application 116A.

Social media applications 116A and 116B may each be representative of an application providing a user interface for interacting with a content sharing platform. The content sharing platform may be hosted by social media platform backend 118 and allow users, such as subject 140 and user 150, to upload, view, and otherwise interact with (e.g., like, comment, etc.) one or more kinds of user-generated media (e.g., images, videos, etc.). Social media applications 116 may communicate with social media platform backend 118 via one or more wireless communication networks.

In some embodiments, social media application 116A may communicate directly with social media application 116B (and vice versa). Additionally or alternatively, communication between social media applications 116A and 116B may be routed through social media platform backend 118. Communications between social media applications 116A and 116B and social media platform backend 118 may occur via one or more wireless communication networks.

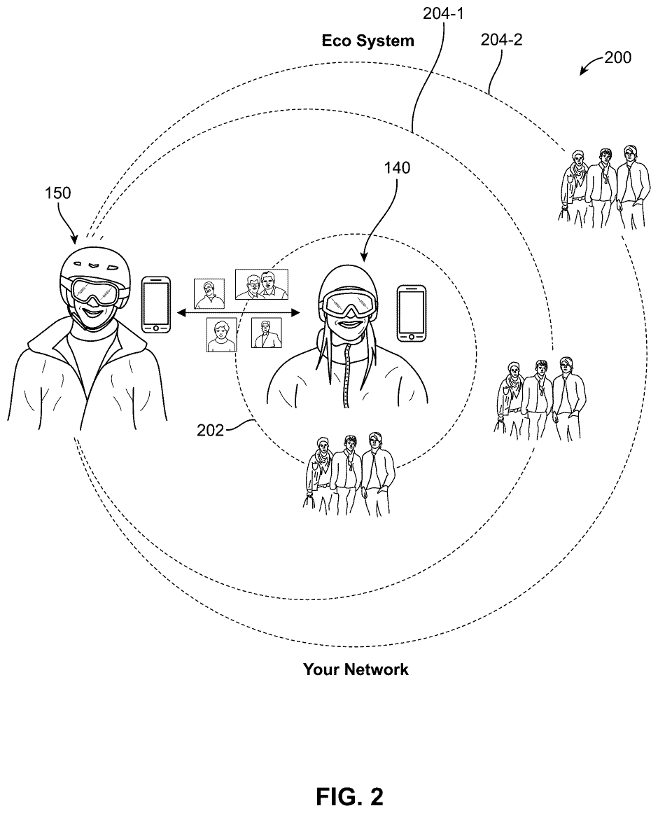

FIG. 2 illustrates a visual representation of the social network of subject 140, in accordance with some embodiments. Social network 200 may comprise subject 140, inner social circle 202, outer social circles 204-1 and 204-2, and user 150. As shown in FIG. 2, subject 140 is at the center of social network 200 and circumscribed by inner circle 202, outer circle 204-1, and outer circle 204-2 respectively. In some embodiments, the distance of each circle from subject 140 (i.e. the center) may represent a relative degree of connection to subject 140. For example, as illustrated in FIG. 2, inner circle 202 may represent the highest degree of connection to subject 140, while outer circle 204-2 may represent the lowest degree of connection to subject 140.

Inner circle 202 may represent one or more users to whom subject 140 is most closely connected. In some embodiments, inner circle 202 may include users to whom subject 140 is directly connected on a content sharing platform (e.g. platform accessed via social media applications 116). User 150 is considered directly connected with subject 140 if both subject 140 and user 150 have mutually agreed to connect on the content sharing platform. For example, either subject 140 or user 150 may send, to the other, a request to connect on the platform. The recipient user may respond by accepting the request. Consequently, subject 140 and user 150 become directly connected to one another. In other embodiments, inner circle 202 may include one or more users directly connected with subject 140 on the content sharing platform and indicated by subject 140 as “close connections” or “close friends.”

Outer circles 204 may represent groups of users to whom subject 140 is not directly connected. In some embodiments, users in outer circle 204-2 may be directly connected to one or more users in inner circle 204-1 of subject 140's social network 200. As such, outer circle 204-2 may comprise users who are directly connected to one or more people in outer circle 204-1, but not to directly connected to subject 140 or any user in inner circle 202.

While FIG. 2 illustrates an embodiment including two outer circles (204-1 and 204-n), a person of skill in the art will appreciate that other embodiments may include n number of outer circles having a decreasing level of connection to subject 140 as their reference numbers increase from 204-1 to 204-n. Furthermore, it is to be understood that the nature and degree to which members of each outer-circle 204 are connected to subject 104 and/or members of inner circle 202 may differ based on the configuration of the content sharing platform, implementation of the authorization process, and/or user preferences set by subject 140.

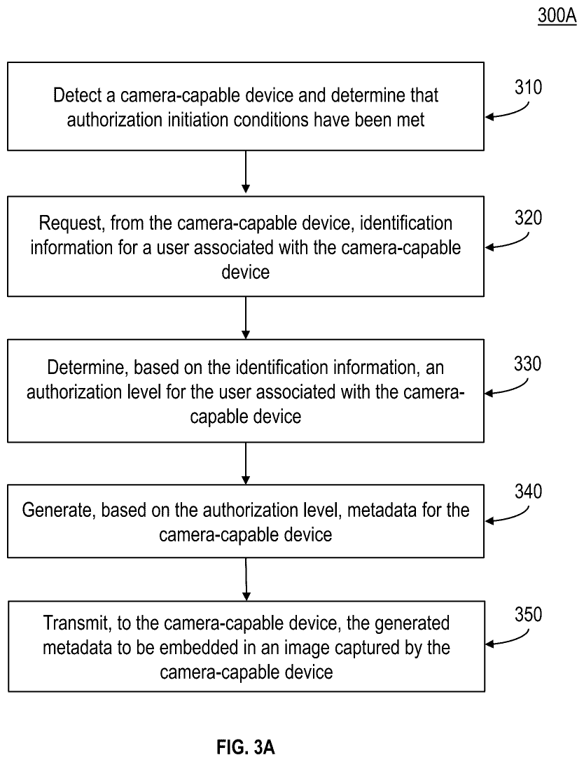

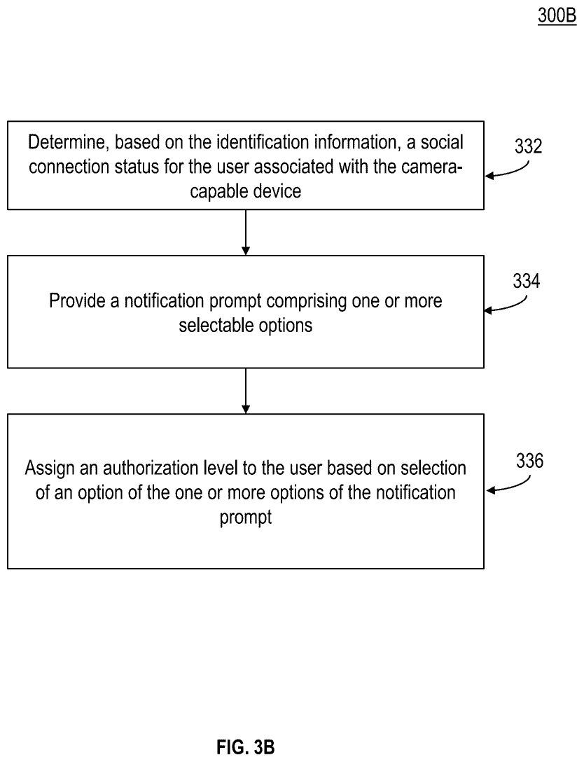

FIGS. 3A and 3B illustrate flowcharts of example methods for implementing controlled sharing of media containing the subject and captured by a camera-capable device associated with a different user, in accordance with some embodiments. Methods 300A and 300B may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, the steps in FIGS. 3A and 3B may not need to be performed in the exact order shown, as will be understood by a person of ordinary skill in the art. Accordingly, the scope of embodiments of the invention should not be considered limited to the specific arrangement of steps shown in FIGS. 3A and 3B.

Method 300A shall be described with reference to FIG. 1. However, method 300A is not limited to that example embodiment.

FIG. 3A depicts a flowchart of an example method 300A for controlling the access and/or sharing of media containing a subject 140 and captured by the camera-capable device associated with a user 150. Method 300A may be performed, for example, by wearable device 102 executing media capture authorization application 106, mobile device 108 executing wearable device application 114, or both. At 310, wearable device 102 may detect the presence of a camera-capable device 110 using one or more sensors 104. Wearable device 102 may be worn by subject 140, and camera-cable device 110 may belong to user 150. It is then determined whether authorization initiation conditions have been met by using media capture authorization application 106 to analyze sensor data from sensor 104. As described above, authorization initiation conditions may include, without limitation, determining that the detected camera-capable device 110 is within a predetermined distance (range) of wearable device 102, the camera of camera-capable device 110 is active (i.e., in media capturing mode), and/or subject 140 is within the field of view of the camera of camera-capable device 110. In some embodiments, such determination is performed by media capture authorization application 106 on wearable device 102. In other embodiments, such determination is performed by wearable device application 114 based on information received by mobile device 108 from sensor 104.

After determining that the conditions are met for initiating the process for authorizing camera-capable device 110 and associated user 150, the authorization process may be initiated at 320. The authorization process may be initiated by, for example, media capture authorization application 106 on wearable device 102 or wearable device application 114 on mobile device 108. This initiation may comprise sending a request to camera-capable device 110 for identification information for user 150. Camera-capable device 110 may respond to the request with the identification information for user 150. The identification information may include one or more of a first and last name for user 150, a username of user 150 associated with social media application 116A, an email address for user 150, or other contact information for user 150.

At 330, after receiving identification information for user 150, an authorization level for user 150 may be determined. For example, wearable device application 114 may generate and send a request for the connection status of user 150 with respect to subject 140 to social media application 116B. The request may include the identification information for user 150 and authentication information for subject 140. The authentication information for subject 140 may be used by social media application 116B to authenticate subject 140 and confirm subject 140's identity. Authenticating subject 140 ensures that information regarding subject 140's social network, activity history, etc. is only shared with subject 140. In some embodiments, the request to social media application 116B sends identification information for user 150 without also sending authentication information for subject 140. Social media application 116B may use its own authentication information for subject 140 based on previously-stored information, or social media application 116B may request that subject 140 separately logs into social media application 116B. In some embodiments, social media application 116B acts on the received identification information for user 150 by referring to an account that is already logged in on social media application 116B.

Alternatively, the request comprising identification information for user 150 and authentication information for subject 140 may be sent directly to a social media platform backend, such as social media platform backend 118, bypassing a social media application on the subject's device (such as social media application 116B) entirely. In some embodiments, a user authentication token may be requested from social media application 116B to include in the request to social media platform backend 118.

A response may then be received indicating whether user 150 is within subject 140's social network. In some embodiments, the degree and/or nature of the connection between subject 140 and user 150 may be received, if a connection exists. A social connection status for user 150 may be determined based on the response. In some embodiments, wearable device application 114 may send a response to media capture authorization application 106 including the social connection status determined for user 150. In other embodiments, this information is used by wearable device application 114 itself in furtherance of method 300A.

An authorization level for user 150 may be determined based on the social connection status included in the response. This may be accomplished by applying a set of media security configurations for subject 140. These security configurations may include user preferences set by subject 140 indicating the connection statuses required for a third party, such as user 150, to gain permission to capture, view, save, and/or share media using camera-capable device 110 during a period of time when conditions for initiating authorization have been met and in which subject 140 is depicted. As noted above, subject 140 may use wearable device application 114 to set and update these preferences as well as other preferences related to the use of wearable device 102.

In some embodiments, user preferences and configurations for wearable device 102 may be stored in mobile device 108 as part of wearable device application 114's application data. Accordingly, when subject 140 makes changes to and/or updates these configurations and preferences, the configurations and preferences may be updated in on mobile device 108. If wearable device 102 is conducting the authorization process, media capture authorization application 106 may request the latest set of privacy configurations from mobile device 108 and wearable device 116. Alternatively, if subject 140's configuration settings are saved to a datastore within backend services 112, media capture authorization application 106 may request updated configurations directly from backend services 112.

The security configurations can then be applied to the social connection status of user 150 within subject 140's social network to determine an authorization level for user 150 and their camera-capable device 110.

At 340, once an authorization level for user 150 has been determined, a camera control signal or metadata to be sent to camera-capable device 110 may be generated based on the authorization level. A camera control signal may be generated if the authorization level for user 150 indicates that user 150 does not have authorization to even capture an image of subject 140. The camera control signal generated may be, for example, a camera blocking signal configured to block the media capturing function of camera-capable device 110. Alternatively, if the authorization level of user 150 indicates that user 150 has authorization to capture an image of subject 140, metadata with further permission details to be embedded in the captured image may be generated.

At 350, the generated camera control signal or metadata may be transmitted to camera-capable device 110 via a wireless network connection. In some embodiments, the camera control signal may prevent camera-capable device from capturing media. For example, a media capture function of camera-capable device 110 (e.g., camera application) may be configured to disable the media capture button upon receiving the camera control signal. In another example, the camera control signal may return a signal at a frequency known or otherwise programmed to block the media capture function. In yet another example, the camera control signal may contain instructions that instruct the camera-capable device not to execute the media capture function.

In some embodiments, the media capture function of camera-capable device 110 may be configured to embed the media it captures with the metadata received from wearable device 102 or mobile device 108. The metadata may be configured to enforce a level of access to the captured media allowed by the authorization level of user 150. For example, if user 150 is assigned an authorization level that allows user 150 to view and save the image of subject 140 but not share the image, the metadata embedded in the image will indicate that the image is not sharable and thus make it incompatible for sharing on a content sharing platform. In another example, if user 150 is assigned an authorization level that does not allow user 150 to even view the image of subject 140, the metadata embedded in the image will indicate that the image is not viewable and thus make it incompatible for display on a device of user 150, such as camera-capable device 110.

In some embodiments, if user 150 is assigned an authorization level that does not allow capture and/or other functionality of media including subject 140, media capture authorization application 106 and/or wearable device application 114 may generate a separate camera control signal to be sent to camera-capable device 110 each time camera-capable device 110 is set to media capturing mode. Similarly, media capture authorization application 106 and/or wearable device application 114 may generate new metadata to be transmitted to camera-capable device 110 for each piece of media captured while authorization initiation conditions are met and in effect. For each piece of media captured, the metadata generated may include a unique media identifier indicating the media in which the metadata should be embedded.

FIG. 3B depicts a flowchart of an example method 300B for performing step 330 of method 300A. Specifically, method 300B describes an example method for determining an authorization level for a user associated with camera-capable device, in accordance with some embodiments.

Method 300B shall be described with reference to FIG. 1 and FIG. 2. However, method 300B is not limited to those example embodiments.

At 332, a social connection status for user 150 may be determined using the methods described above in step 330 of method 300A. If user 150 falls within a social connection status for which subject 140's security preferences indicate authorization should automatically be granted, an authorization level indicating that user 150 is authorized may be determined and method 300B ends. If user 150 falls within a social connection status for which subject 140's security preferences indicate authorization should automatically be denied, an authorization level indicated that user 150 is not authorized may be determined and method 300B ends. But if subject 140's security preferences do not indicate an automatic authorization action, and/or if subject 140's security preferences indicate that a notification should be sent to subject 140, method 300B continues.

At 334, a notification may be provided to subject 140. The notification may be generated based on the social connection status determined for user 150 and security preferences set by subject 140. For example, user 150 may be assigned a social connection status indicating that user 150 is in subject 140's outer circle 204-2. Furthermore, subject 140's security preferences may indicate that a notification be displayed to subject 140 when a detected camera-capable device is associated with a user in outer circles 204.

In some embodiments, the notification may be displayed on a screen of a mobile device associated with the subject, such as mobile device 108. In some embodiments, if wearable device 102 is an eyewear, the notification may be displayed on a heads-up display accessible via the eyewear. In some embodiments, if wearable device 102 contains an audio device such as a speaker, or if the mobile device 108 is paired to an audio device such as headphones, the notification may be provided in audio form to the audio device.

The notification may include two or more selectable options and a prompt instructing subject 140 to select one of the two or more options. Some non-limiting examples of the two or more options may include, but are not limited to, authorizing user 150 to access to media containing subject 140, denying authorization to user 150 to access media containing subject 140, sending a request to connect with user 150, dismissing the notification prompt without taking action, and requesting a list of possible authorization levels in order to manually select a specific authorization level for user 150.

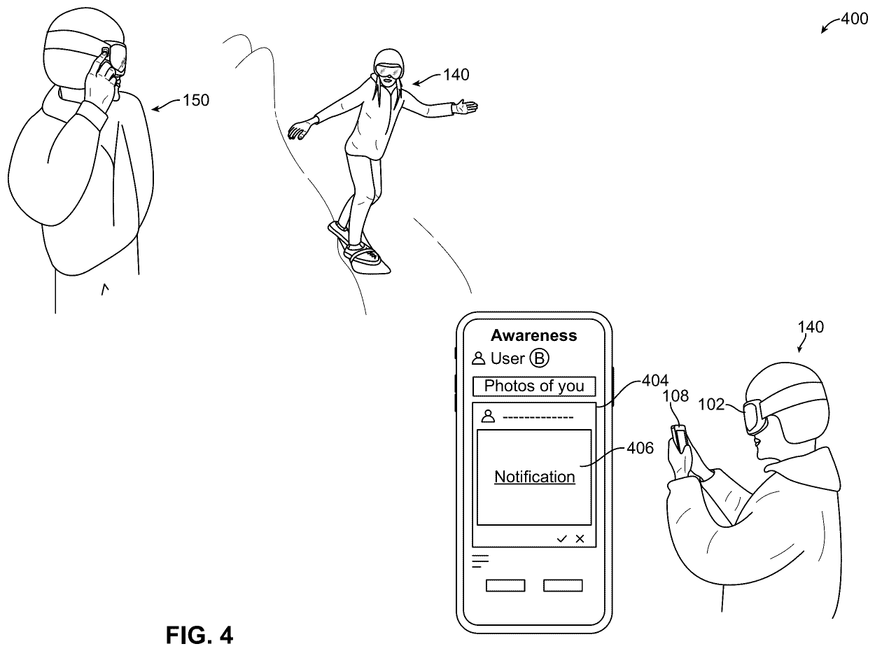

In some embodiments, the notification may be displayed as a heads up notification on the eyewear component of wearable device 102. In such embodiments, user 140 may make a selection via voice command. Additionally or alternatively, user 140 may make a selection via the lock screen of mobile device 108, an application interface executing on mobile device 108, or via wearable device application 114. In some embodiments, the notification may be displayed on mobile device 108 as depicted in FIG. 4.

At 336, wearable device 102 may assign an authorization level to user 150 based on the selection, by user 140, of one of the two or more options provided in the notification. As described above, a camera control signal to disable the media capturing functionality of camera-capable device 110 or metadata to be embedded in media captured by camera-capable device 110 may then be generated based on the authorization level of user 150 and sent to camera-capable device 110.

FIG. 4 illustrates a visual representation of the example methods of FIGS. 3A and 3B, in accordance with some embodiments. Notification user interface 404 may be an example user interface for displaying the notification prompt 406 described in step 334 of method 300B.

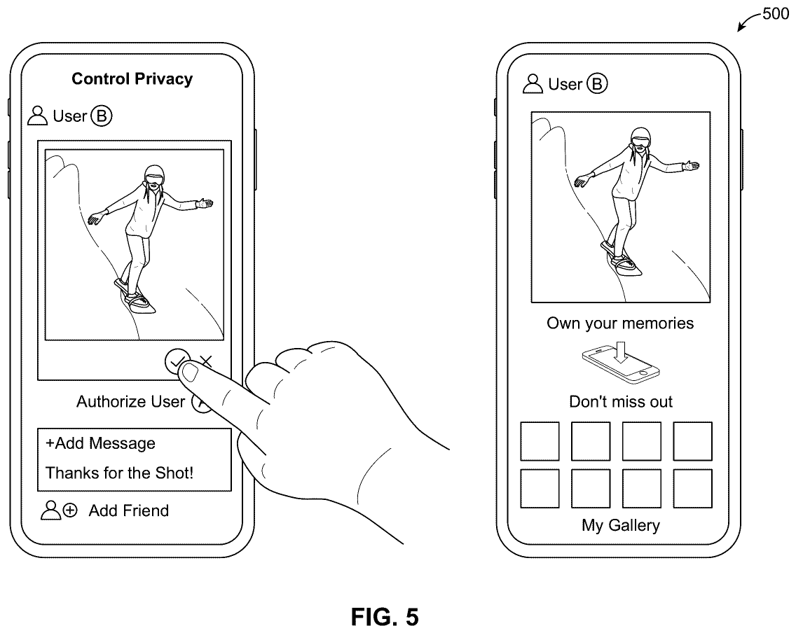

FIG. 5 illustrates example user interfaces for viewing and downloading media including the subject and captured by a camera-capable device associated with a third-party user, in accordance with some embodiments. In some embodiments, wearable device 102 and/or wearable device application 114 may integrate with social media application 116B such that subject 140 may view, download, like, and otherwise interact with media embedded with metadata associated with subject 140 within wearable device application 114. Additionally or alternatively, the integration may allow subject 140 to quickly find and view, within social media application 116B, all media tagged with metadata from user 140's wearable device 102 and/or mobile device 108. In some embodiments, wearable device application 114 may automatically download media tagged with metadata from wearable device 102 and/or mobile device 108.

In some embodiments, wearable device application 114 may allow subject 140 to download images captured by camera-capable device 110 and embedded with metadata from their wearable device 102 even when the images have not been viewed and/or shared by user 150. For example, wearable device application 114 may be configured to instruct camera-capable device to automatically transmit the captured image to subject 140's mobile device 108 upon capture by camera-capable device 110. Alternatively, wearable device 102 and/or wearable device application 114 may present subject 140 with a prompt with options to download and/or share the image. In some embodiments, the prompt may include a preview of the image received from camera-capable device 110. Wearable device application 114 may allow subject 140 to determine whether captured images are automatically downloaded to mobile device 108 via configuration of a user preference. This user preference may be part of the media security configurations for subject 140.

FIG. 6 illustrates a visual representation of the social networks of multiple subjects in relation to a user of a camera-capable device, in accordance with some embodiments. In some embodiments, there may be multiple subjects 620, 630, and 640, each wearing an electronically enabled wearable device running an instance of media capture authorization application 106. Each subject may have a social network comprising an inner circle and two outer circles. For example, subject 620's social network may comprise inner circle 622 and outer circles 624 and 626. Similarly, subject 630's social network may comprise inner circle 632 and outer circles 634 and 636, and subject 640's social network may comprise inner circle 642 and outer circles 644 and 646. As described with respect to FIG. 2, these social networks may comprise n number of outer circles. Each circle of a social networks may include one or more people connected to the respective subject.

As shown in FIG. 6, the social networks of subjects 620, 630, and 640 may overlap. This may occur when one person, such as user 610, is connected to all three subjects 620, 630, and 640. User 610 may fall within a different social circle in the social networks of subjects 620, 630, and 640. For example, user 610 may be in the first outer circle 644 of subject 640's social network and the second outer circles 626 and 636 of the social networks of subjects 620 and 630 respectively. In another scenario, if user 610 is only connected to subject 620 and 640, but not subject 630, the social networks of subjects 620 and 640 may overlap, but not the social network of subject 630. Or, the social network of subject 630 may still overlap with either one or both social networks of subject 620 and 640 if subject 630 has another common connection with one or both of subjects 620 and 640. Furthermore, subjects 620, 630, and 640 may be connected to each other.

A scenario in which all three subjects 620, 630, and 640 are within the field of view of the camera of a camera-capable device belonging to user 610 may occur. In such a scenario, if user 610 attempts to take a picture including the three subjects, it is important to ensure that the security needs of all three subjects 620, 630, and 640 are met. These security needs may be different for each subject. Accordingly, the security configurations set by each subject may differ, leading to user 610 being given two or more different authorization levels. For example, user 610 may be given authorization to capture and view media including subject 620. Additionally, user 610 may be given authorization to capture, view, save, and share media including subject 640. However, subject 630 may have more strict security configurations and thus user 610 may not be given authorization to capture media including subject 630 at all. In such a situation, it may be necessary to reconcile the different levels of authorization granted to user 610.

Reconciling different levels of authorization granted to user 610 may include determining the level of authorization that allows for the least access and applying that authorization level. For example, in the example given above, subject 630's security configurations give user 610 the least level of access since user 610 cannot even capture a picture of subject 630. As such, reconciliation of the authorization levels granted to user 610 may result in user 610 being prevented from capturing the picture.

In some embodiments, reconciliation of the levels of authorization granted to user 610 by subjects 620, 630, and 640 may include notifying the subjects of the discrepancy. For example, subject 630 may be notified that they have denied user 610 authorization to take a picture and that the other subjects have allowed user 610 a higher level of access. The notification may also include a prompt allowing subject 630 to assign user 610 a more permissive authorization level. The prompt may provide subject 630 with authorization level options from which to choose. These options may include the authorization levels assigned to user 610 by subjects 620 and 640. Alternatively, the prompt may provide subject 630 with the option to select any authorization level that allows greater access to user 610 than the current authorization level given by subject 630. Subject 630 may choose one of the options provided in the prompt, thus granting user 610 higher level of access. Alternatively, subject 630 may decline to change the level of authorization granted to user 610. Subjects 620 and 640 may also receive a notification of the discrepancy. For example, both subjects may receive a notification indicating that another subject (e.g., subject 630) has declined to grant user 610 permission to take a picture. Additionally, the notification may also indicate the level of authorization granted by subject receiving the notification. In some embodiments, if subject 630 chooses select one of the options provided in the prompt they receive, thus assigning a more permissive authorization level to user 610, subjects 620 and 640 may be notified of the change.

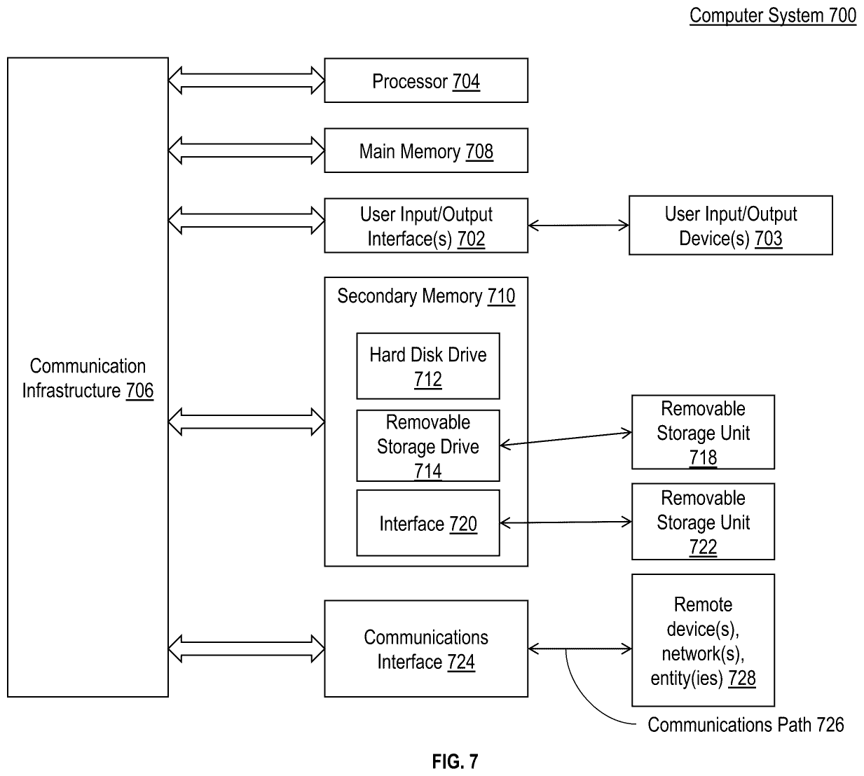

FIG. 7 illustrates an example computer system in accordance with some embodiments. Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a memory; and
at least one processor coupled to the memory and configured to:
cause an electronically-enabled wearable device worn by a subject to detect a nearby camera-capable device;
determine that a camera of the nearby camera-capable device is active;
send, to the camera-capable device, a request for identification information of a user associated with the camera-capable device;
receive, from the camera-capable device, a response comprising identification information for the user;
determine, based on the identification information, an authorization level for the user; and
send, to the camera-capable device, authorization metadata generated for the camera-capable device based on the authorization level for the user, wherein:
the camera-capable device is configured to embed the authorization metadata in media captured by the camera-capable device while the camera-capable device is within range of and remains detectable by the wearable device worn by the subject; and
the authorization metadata is configured to allow or disallow, based on the authorization level of the user, one or more of viewing, saving, or sharing of the captured media.

2. The system of claim 1, wherein the wearable device comprises eyewear.

3. The system of claim 2, wherein the eyewear comprises a goggles, face shield, eyeglasses, or sunglasses.

4. The system of claim 1, wherein the wearable device is in communication with a mobile device associated with the subject.

5. The system of claim 1, wherein the at least one image captured by the camera-capable device includes the subject.

6. The system of claim 5, wherein the authorization level for the user is one of:
a first authorization level indicating that the user is authorized to view, save and share the captured media;
a second authorization level indicating that the user is authorized to view and save the captured media;
a third authorization level indicating that the user is authorized to view the captured image; and
a fourth authorization level indicating that the user is not authorized to view, save, or share the captured media.

7. The system of claim 6, wherein determining an authorization level for the user comprises:
determining, based on the identification information for the user, a social connection status indicating a degree of connection between the subject and the user within a social network of the subject; and
assigning, to the user, an authorization level indicating access rights of the user to the captured media, wherein the authorization level is based on a privacy preference set by the subject and indicating an authorization level for each social connection status value of a set of possible social connection status values.

8. The system of claim 6, wherein determining an authorization level for the user comprises:
determining, based on the identification information for the user, a social connection status for the user indicating a degree of connection between the subject and the user in a social network of the subject;
providing, to the subject, a prompt comprising identification information for the user, a first option, and a second option, wherein:
selection of the first option causes a request to connect to be sent to the user; and
selection of the second option causes the prompt to be dismissed.

9. The system of claim 8, wherein the prompt further comprises a third option and wherein:
selection of the third option causes a selectable list of possible authorization levels to be displayed to the subject; and
selection of an authorization level from the list of possible authorization levels causes the selected authorization level to be assigned to the user.

10. The system of claim 8, wherein selection of the first option or the second option causes an authorization level to be assigned to the user based on a user configuration set by the subject indicating an authorization level based on the selected prompt option.

11. The system of claim 8, wherein the prompt is presented to the subject as a heads-up display on the electronically-enabled wearable device.

12. The system of claim 1, wherein the media captured by the camera-capable device is an image.

13. The system of claim 1, wherein the media captured by the camera-capable device is a video.

14. A computer-implemented method comprising:
detecting, by an electronically-enabled wearable device worn by a subject, a nearby camera-capable device;
determining that a camera of the nearby camera-capable device is active;
sending, to the camera-capable device, a request for identification information of a user associated with the camera-capable device;
receiving, from the camera-capable device, a response comprising identification information for the user;
determining, based on the identification information, an authorization level for the user; and
sending, to the camera-capable device, a camera control signal generated for the camera-capable device based on the authorization level for the user, wherein the camera-capable device is configured to disable the media capturing function of the camera-capable device upon receiving the camera control signal.
